(19) United States
(12) Patent Application Publication
(10) Pub. No.: US 2016/0247172 A1
(43) Pub. Date: Aug. 25, 2016

(54) SYSTEM AND METHOD FOR FORECASTING CROSS-PROMOTION EFFECTS FOR MERCHANDISE IN RETAIL

(71) Applicant: ORACLE INTERNATIONAL CORPORATION, Redwood Shores, CA (US)

(72) Inventors: Ming LEI, Lutherville-Timonium, MD (US); Catalin POPESCU, Atlanta, GA (US); Mark STADTER, Roswell, GA (US)

(21) Appl. No.: 14/628,397

(22) Filed: Feb. 23, 2015

(51) Int. Cl. G06Q 30/02

(52) U.S. Cl. CPC G06Q 30/0202

(57) ABSTRACT

Systems, methods, and other embodiments that are associated with a computer application configured to execute on a computing device, for providing forecasting and management of cross-promoted retail items, are described. In one embodiment, historical demand data and elasticity values associated with retail items sold at a retail location are read from a data structure. The historical demand data represents past sales of the retail items across a plurality of past retail periods, and the elasticity values represent how a change in the demand of one retail item affects changes in the demand of other retail items. Cross-promotion values for affected retail items are generated, based at least in part on the historical demand data and the elasticity values, representing a predicted future change in a demand for the affected retail items due to the planned promotion of another retail item.

### BACKGROUND

A retail business needs to manage its supply chain of products. In one aspect, computer applications are used to manage inventory of products and determine demand forecasts based on promotions. Forecasting demand is a big part of managing a retail business and is a key driver of the supply chain. In retail, when a product (e.g., a brand name apple flavor yogurt) is promoted, the sales of the promoted product will usually increase.

However, the sales of products which are sharing the same market as the promoted product (e.g., private label apple flavor yogurt) may decrease due to the cannibalization effect. The cannibalization effect is due to an increase in sales of one product taking away sales from another similar product. Furthermore, for example, when a product (e.g., a hot dog) is promoted, the retailer may see demand increase for both the promoted product as well as complimentary products (e.g. hot dog buns) due to the halo effect. The halo effect is due to an increase in sales of one product adding to sales for another complementary product.

To increase the revenue or profit via product promotion, retailers should understand the cross-promotion effects (cannibalization/halo effects) in order to generate accurate demand forecasts and optimize inventory management. It has been challenging for a retailer to identify the cross promotion effects between the correct product pairs among the many products the retailer carries, quantify the cross promotion effects, and correctly apply the cross promotion effects when forecasting demand.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with a cross-promotion forecasting tool;

FIG. 2 illustrates one embodiment of a method, performed by the cross-promotion forecasting tool of the computer system of FIG. 1, for forecasting changes in demand of a set of retail items due to promotion of another retail item;

FIG. 3 illustrates one embodiment of a portion of the method of FIG. 2 for generating a crossover amount;

FIG. 4 illustrates one embodiment of a portion of the method of FIG. 3 for generating a cross change ratio;

FIG. 5 illustrates one embodiment of a portion of the method of FIG. 2 for generating a spreading profile;

FIG. 6 illustrates a first portion of one example embodiment of tables of data generated by the cross-promotion forecasting tool of FIG. 1 by executing the method of FIGS. 2-5;

FIG. 7 illustrates a second portion of the example embodiment of FIG. 6 showing tables of data; and

FIG. 8 illustrates one example embodiment of a computing device upon which a cross-promotion forecasting tool of a computing system may be implemented.

### DETAILED DESCRIPTION

Systems, methods, and other embodiments, for generating cross-promotion effects between retail items, associated with a computer application are disclosed. Example embodiments are discussed herein with respect to computerized retail demand forecasting and management, where cross-promotion effects between retail products are taken into consideration. In one embodiment, a cross-promotion forecasting (CPF) tool is disclosed that is configured to predict a future change in demand for one or more target retail items due to the planned promotion of a driver retail item. Managing promotions of retail items to accurately forecast demand, balance inventory, and promote maximization of sales revenue is disclosed herein.

The following terms are used herein with respect to various embodiments.

The term “retail item”, as used herein, refers to merchandise sold, purchased, and/or returned in a retail environment. The term “driver retail item”, as used herein, refers to a retail item, that when promoted, affects sales (demand) of at least one other retail item. The term “target retail item”, as used herein, refers to a retail item whose sales (demand) is affected when another retail item is promoted.

The term “retail calendar”, as used herein, refers to a calendar that is used by retailers which is organized into accounting periods (e.g., quarters) for a retail year which can be made to correspond to the same periods for subsequent years, providing an invaluable forecast tool for management. For example, a retail calendar year may have 52 retail periods where each retail period corresponds to a 7-day week. In one embodiment, a retail calendar is stored and manipulated in electronic form as part of a retail calendar computer application, for example.

The term “retail period”, as used herein, refers to a unit increment of time (e.g., a 7-day week) which retailers use to correlate seasonal retail periods from one year to the next in a retail calendar for the purposes of planning and forecasting. The terms “retail period” and “calendar period” may be used interchangeably herein.

The term “retail location”, as used herein, may refer to a physical store where a retail item is sold, or to an on-line store via which a retail item is sold.

The term “historical demand data”, as used herein, refers to sales and promotion information, that have been recorded for retail items, associated with past retail periods.

The term “cross-promotion value”, as used herein, represents a predicted future change in demand for one retail item due to the planned promotion of another retail item.

In one embodiment, a computer algorithm is disclosed that implements a profile-based approach which determines cross-promotion effects in promotion planning or demand forecasting activities. It is assumed herein that product pairs have been identified in which cross-promotion effects exist, and that the cross promotion effects have been quantified. For example, a regression technique may be used to identify the product pairs and a multiplicative model may be used to quantify the cross-promotion effects.

In accordance with one embodiment, for an identified product pair (e.g., a driver retail item and a target retail item), the ratio of the sales lift units of the promoted driver retail item and the sales change of the target retail item is calculated. The sales change of the target retail item will be positive for a halo effect and negative for a cannibalization effect. A cross-promotion profile is determined based on the quantified cross-promotion effects and the base demand of the paired products. The profile balances the cross-promotion effects and the market share of the paired target retail product. Demand created by the cross-promotion effects takes into account historical values, such that the effects are not overestimated.

Such a profile-based cross-promotion effect approach allows a retailer to have insight into the cross-promotion effects of merchandise and enables the retailer to more effectively manage promotion planning, demand forecasting, and inventory management. A retailer can see significant revenue and/or profit increase by more effectively promoting merchandise and by having the right inventory levels. In the following, a computer-implemented methodology to estimate the cross-promotion effects between retail items is presented. In one embodiment, a cross-promotion forecasting (CPF) tool is configured to perform the methodology.

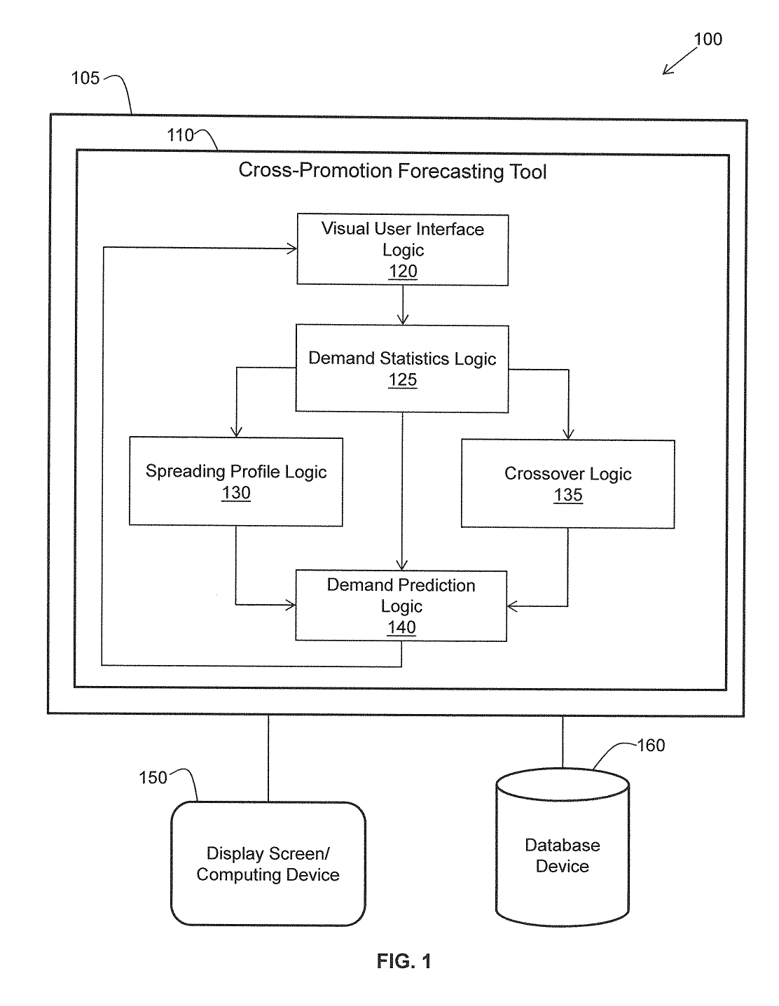

FIG. 1 illustrates one embodiment of a computer system 100, having a computing device 105 configured with a cross-promotion forecasting (CPF) tool 110. For example, in one embodiment, the CPF tool 110 may be part of a larger computer application of a retail company, configured to forecast and manage sales and promotions for retail items at various retail locations. The CPF tool 110 is configured to computerize the process for predicting cross-promotion effects. In one embodiment, the software and computing device 105 may be configured to operate with or be implemented as a cloud-based networking system, a software-as-a-service (SaaS) architecture, or other type of computing solution.

With reference to FIG. 1, in one embodiment, the CPF tool 110 is implemented on the computing device 105 and includes logics for implementing various functional aspects of the CPF tool 110. In one embodiment, the CPF tool 110 includes visual user interface logic 120, demand statistics logic 125, spreading profile logic 130, crossover logic 135, and demand prediction logic 140. The various logics illustrated in FIG. 1 are operably connected to each other within the CPF tool 110.

The computer system 100 also includes a display screen 150 operably connected to the computing device 105. In accordance with one embodiment, the display screen 150 is implemented to display views of and facilitate user interaction with a graphical user interface (GUI) generated by the visual user interface logic 120 for viewing and updating information associated with cross-promotion effects. The graphical user interface may be associated with a cross-promotion forecasting application and the visual user interface logic 120 may be configured to generate the graphical user interface. In one embodiment, the CPF tool 110 is a centralized server-side application that is accessed by many users. Thus the display screen 150 may represent multiple computing devices/terminals that allow users to access and receive services from the CPF tool 110 via networked computer communications.

In one embodiment, the computer system 100 further includes at least one database device 160 operably connected to the computing device 105 and/or a network interface to access the database device 160 via a network connection. In accordance with one embodiment, the database device 160 is configured to store and manage data structures (e.g., records of historical demand data, elasticity values, and cross-promotion values) associated with the CPF tool 110 in a database system (e.g., a computerized inventory and demand forecasting application).

Other embodiments may provide different logics or combinations of logics that provide the same or similar functionality as the CPF tool 110 of FIG. 1. In one embodiment, the CPF tool 110 is an executable application including algorithms and/or program modules configured to perform the functions of the logics. The application is stored in a non-transitory computer storage medium.

Referring back to the logics of the CPF tool 110 of FIG. 1, in one embodiment, the visual user interface logic 120 is configured to generate a graphical user interface to facilitate user interaction with the CPF tool 110. For example, the visual user interface logic 120 includes program code that generates and causes the graphical user interface to be displayed based on an implemented graphical design of the interface. In response to user actions and selections via the GUI, associated aspects of cross-promotion for retail items may be manipulated.

For example, the visual user interface logic 120 is configured to facilitate receiving inputs and reading historical demand data and elasticity values, associated with a set of target retail items and a driver retail item sold at a retail location, from at least one data structure associated with (and accessible by) a cross-promotion forecasting application (e.g., the CPF tool 110) via the graphical user interface. Demand for the target retail items in the set of target retail items is affected by promotion of the driver retail item at the retail location.

Historical demand data may include, for example, sales data representing past sales of the driver retail item and the target retail items in the set of target retail items across a plurality of past retail periods. The historical demand data and the elasticity values may be accessed via network communications. In one embodiment, the elasticity values are estimated based at least in part on the historical data. The historical demand data may be segmented into retail periods of past weeks, with each past week having numerical values assigned to it to indicate the number of items sold for that week, in accordance with one embodiment. An elasticity value of the elasticity values represents how sensitive demand for a corresponding target retail item, in the set of target retail items, is to a change in demand for the driver retail item. That is, an elasticity value represents how a change in the demand of the driver retail item affects a change in the demand of an associated target retail item.

Furthermore, the visual user interface logic 120 is configured to facilitate the outputting and displaying of cross-promotion values, via the graphical user interface, on the display screen 150, where the displayed cross-promotion values represent predicted future changes in demand (e.g., in retail item units) for the target retail items due to the planned promotion of the driver retail item. In one embodiment, demand prediction logic 140 is configured to operably interact with the visual user interface logic 120 to facilitate displaying of cross-promotion values of an output data structure.

In one embodiment, the demand statistics logic 125 is configured to generate a baseline demand value for individual target retail items in the set of target retail items based on, at least in part, the historical demand data. The baseline demand value represents average sales of a target retail item in the set of target retail items across a plurality of past retail periods. The demand statistics logic 125 is also configured to generate a cross-promotion value for the individual target retail items in the set of target retail items. A cross-promotion value generated by the demand statistics logic 125 represents a predicted maximum change in the demand for an associated target retail item with respect to a corresponding baseline demand value due to past promotion of the driver retail item.

In one embodiment, the crossover logic 135 is configured to generate a crossover amount based on, at least in part, the historical demand data. The crossover amount represents a portion of an expected future change in demand of the driver retail item that accounts for a total expected future change in demand for the set of target retail items due to a planned promotion of the driver retail item. The crossover amount may be distributed across the set of target retail items stored as values in a data structure, based at least in part on the historical demand data and the elasticity values, to form cross-promotion values for the set of target retail items. A resulting cross-promotion value distributed to a target retail item represents a predicted future change in a demand for the target retail item. In one embodiment, the demand prediction logic 140 is configured to perform the distribution function to distribute the crossover amount.

In one embodiment, the spreading profile logic is configured to generate a spreading profile based on, at least in part, the historical demand data and the elasticity values. The spreading profile represents how to distribute the crossover amount across the set of target retail items stored as values in a data structure. The demand prediction logic 140 is configured to generate a cross-promotion value for the individual target retail items of the set of target retail items based on, at least in part, the spreading profile and the crossover amount.

The cross-promotion value represents a predicted future change in demand for an associated target retail item due to the planned promotion of the driver retail item. The demand prediction logic is also configured to select a minimum of the cross-promotion value generated by the demand prediction logic 140 and the cross-promotion value generated by the demand statistics logic 125 as a final cross-promotion value for the individual target retail items in the set of target retail items. The final cross-promotion value represents a final predicted future change in demand for an associated target retail item.

In accordance with one embodiment, the demand prediction logic 140 is configured to transform an output data structure (e.g., associated with the CPF tool 110) by populating the output data structure with cross-promotion values. The cross-promotion values may be those generated by the demand statistics logic 125, the demand prediction logic 140, or both. Furthermore, the demand prediction logic 140 is configured to operably interact with the visual user interface logic 120 to facilitate displaying, on the display screen 150, the cross-promotion values in the output data structure via the graphical user interface.

In this manner, a cross-promotion forecasting tool 110 (e.g., implemented as part of a larger computer application) can accurately predict the effects of cross-promotion between a promoted driver retail item and a set of target retail items. As a result, a retailer may use the prediction to more accurately determine a promotion strategy (e.g., which retail item to promote and at what price) and more accurately determine a quantity of the retail items to order.

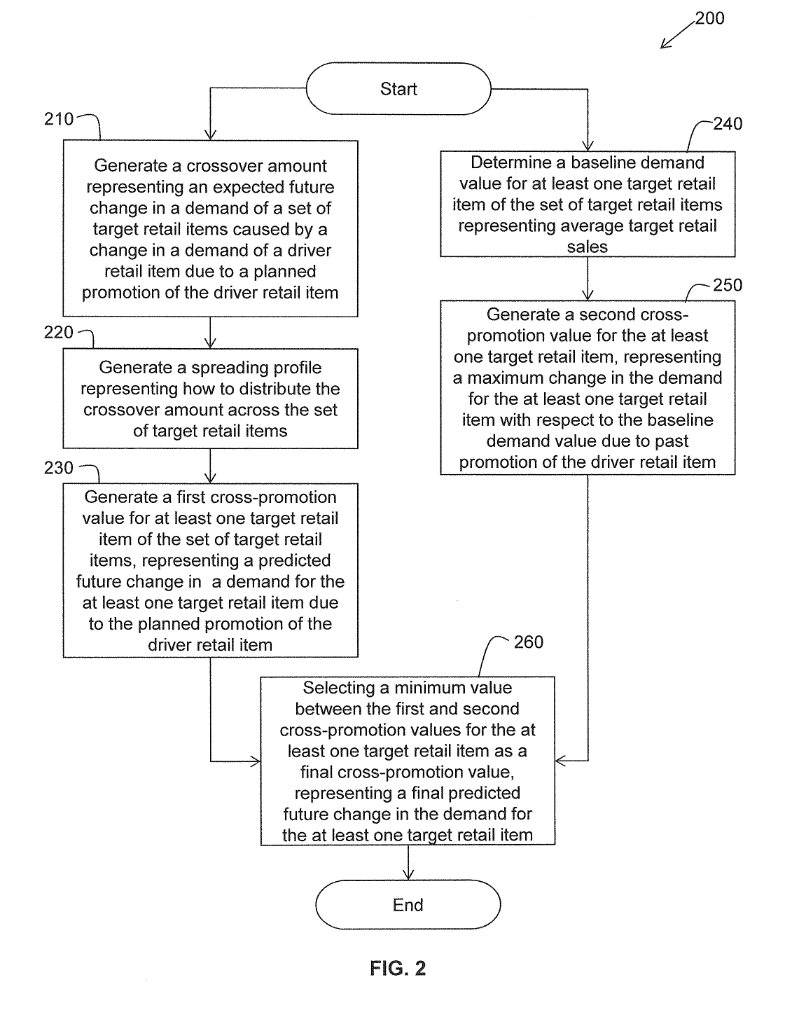

FIG. 2 illustrates one embodiment of a method 200, performed by the cross-promotion forecasting (CPF) tool 110 of the computer system 100 of FIG. 1, for forecasting changes in demand of a set of retail items due to promotion of another retail item. Method 200 summarizes the operation of the CPF tool 110 and is implemented to be performed by the CPF tool 110 of FIG. 1, or by a computing device configured with an algorithm of the method 200.

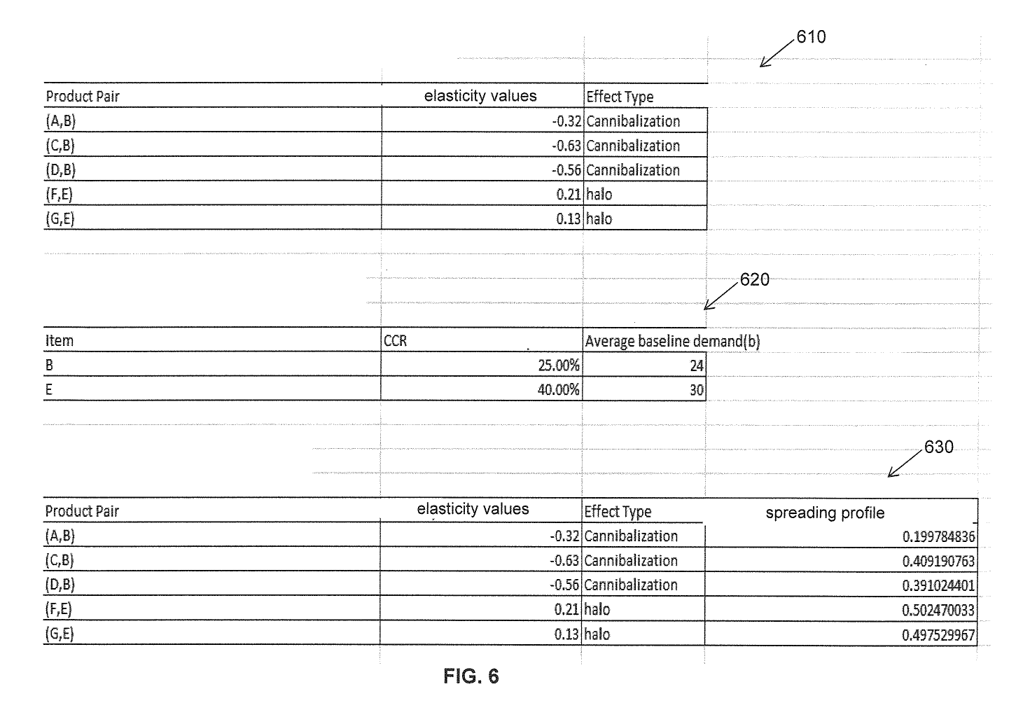

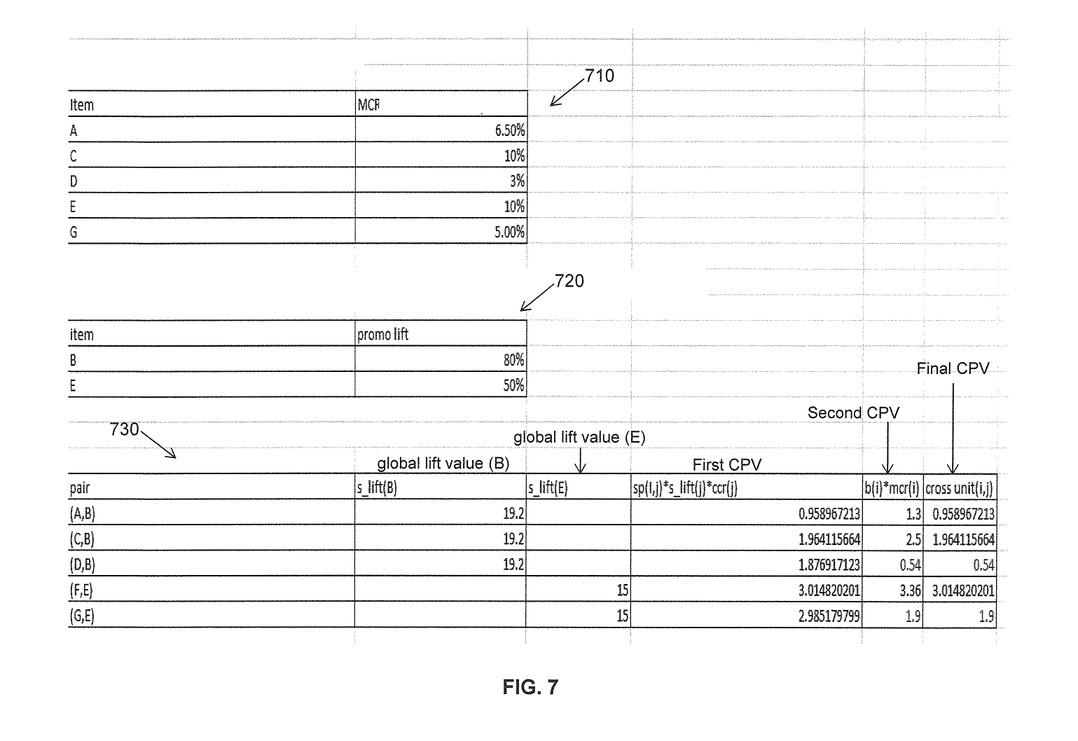

Method 200 will be described from the perspective that, for a set of target retail items sold at a retail location, the demand of the target retail items in the set of target retail items is affected by promotion of a driver retail item at the retail location. Also, a retail calendar has many retail periods (e.g., weeks) that are organized in a particular manner (e.g., four (4) thirteen (13) week quarters) over a typical calendar year. A retail period may occur in the past or in the future. A retail item (i.e., a driver retail item) that is promoted over one or more retail periods may not only result in an increase in sales (demand) for the promoted retail item, but may also result in an increase (halo effect) or decrease (cannibalization) in sales (demand) of other related retail items (i.e., target retail items). An example of the method 200 is discussed later herein with respect to FIG. 6 and FIG. 7.

In accordance with one embodiment, the CPF tool 110 is configured to read historical demand data from at least one data structure. The historical demand data represents past sales of the driver retail item and of the target retail items in the set of target retail items across a plurality of past retail periods. The historical demand data may also include information indicating over which past retail periods the driver retail item has been promoted. Furthermore, the historical demand data may include data derived from the sales data (e.g., average sales data over the plurality of past retail periods for a retail item). The CPF tool 110 is also configured to read elasticity values from at least one data structure. An elasticity value, for a target retail item in the set of target retail items, represents how sensitive demand for the target retail item is to a change in demand for the driver retail item.

Upon initiating method 200, at block 210, a crossover amount is generated based on, at least in part, the historical demand data. The crossover amount represents an expected future change in a demand of a set of target retail items caused by a change in a demand of a driver retail item due to a planned promotion of the driver retail item (e.g., a portion of an expected future change in demand of the driver retail item that accounts for a total expected future change in demand for a set of target retail items due to a planned promotion of the driver retail item). In accordance with one embodiment, the crossover amount is generated by the crossover logic 135 of the cross-promotion forecasting tool 110 in operative cooperation with the demand statistics logic 125. Generation of the crossover amount is discussed below herein with respect to the example of FIG. 6 and FIG. 7.

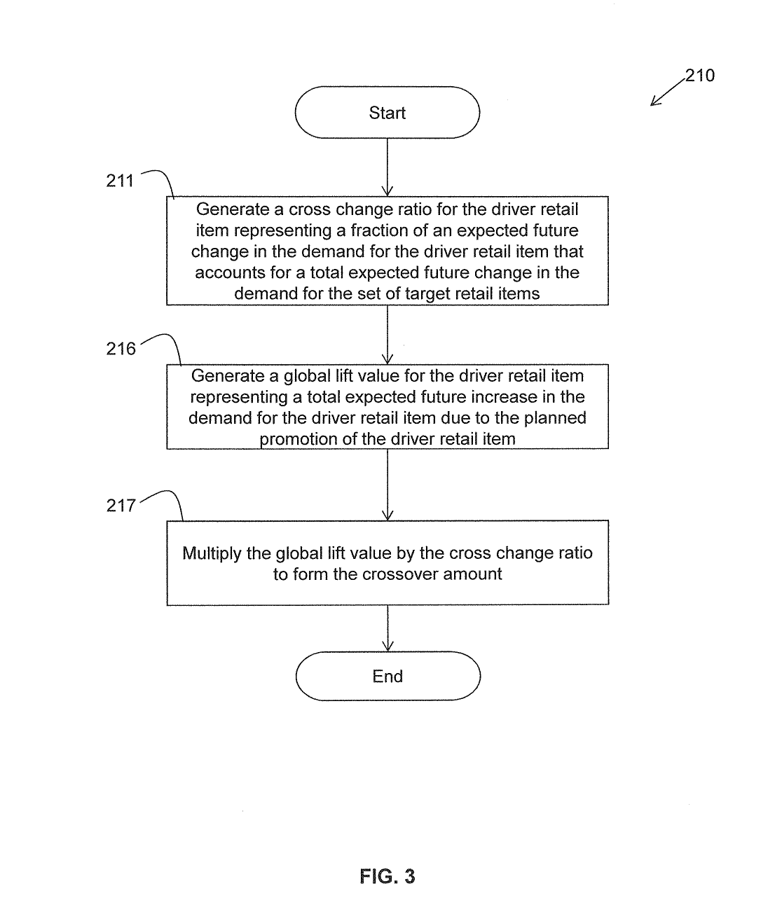

FIG. 3 illustrates one embodiment of a portion of the method 200 of FIG. 2 for generating a crossover amount. In accordance with one embodiment, at block 211, generating the crossover amount includes generating (e.g., calculating) a cross change ratio for the driver retail item based on, at least in part, the historical demand data. The cross change ratio represents a fraction of the expected future change in demand of the driver retail item that accounts for the total expected future change in demand for the set of target retail items.

Generating the crossover amount also includes, at block 216, generating a global lift value for the driver retail item based on, at least in part, the historical demand data. The global lift value represents a total expected future increase in the demand for the driver retail item due to the planned promotion of the driver retail item. Generating the crossover amount further includes, at block 217 multiplying the global lift value by the cross change ratio to form the crossover amount.

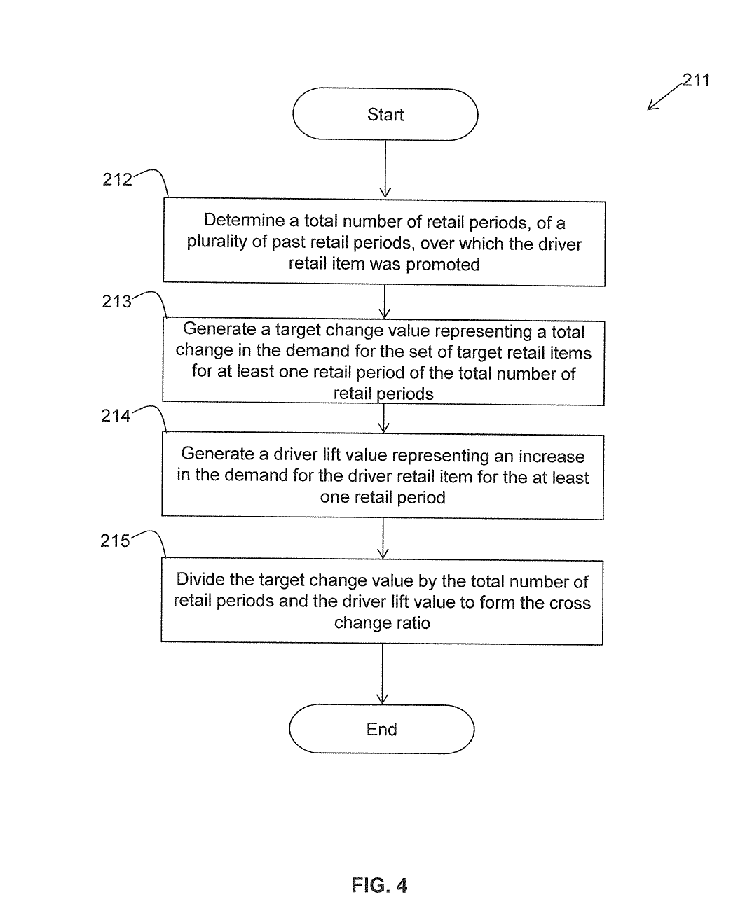

FIG. 4 illustrates one embodiment of a portion of the method 210 of FIG. 3 for generating a cross change ratio. In accordance with one embodiment, at block 212, generating the cross change ratio includes determining (e.g., counting) a total number of retail periods (time periods), of the plurality of past retail periods in the historical demand data, over which the driver retail item was promoted. Determining the total number of retail periods in the historical demand data may include simply reading the total number of retail periods from the historical demand data, in accordance with one embodiment.

Generating the cross change ratio also includes, at block 213, generating a target change value representing a total change in demand for the set of target retail items for at least one retail period of the total number of retail periods over which the driver retail item was promoted. Generating the cross change ratio further includes, at block 214, generating a driver lift value representing an increase in demand for the driver retail item for the at least one retail period of the total number of retail periods over which the driver retail item was promoted. Generating the cross change ratio also includes, at block 215, dividing the target change value by the total number of retail periods and the driver lift value to form the cross change ratio. Generation of the cross change ratio is discussed below herein with respect to the example of FIG. 6 and FIG. 7.

In one embodiment, a weekly cross change ratio may be generated for each week, when the driver retail item is on promotion, by dividing the target change value by the driver lift value for a given week. A final cross change ratio may be generated by averaging all of the weekly cross-change ratios. That is, for each week that qualifies, a cross change ratio may be generated and the final ratio is their average.

Referring again to FIG. 2, at block 220, a spreading profile is generated based on, at least in part, the historical demand data and the elasticity value for the target retail items in the set of target retail items. The spreading profile represents how to distribute the crossover amount across the set of target retail items. In accordance with one embodiment, the spreading profile is generated by the spreading profile logic 130 of the cross-promotion forecasting tool 110 in operative cooperation with the demand statistics logic 125. Generation of the spreading profile is discussed below herein with respect to the example of FIG. 6 and FIG. 7.

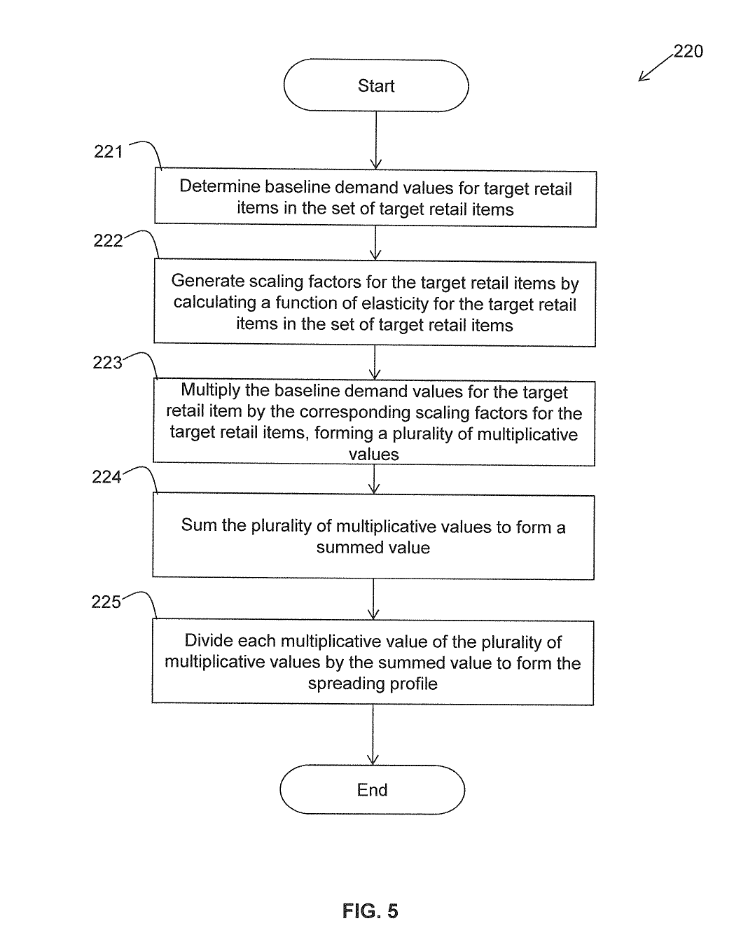

FIG. 5 illustrates one embodiment of a portion of the method 200 of FIG. 2 for generating a spreading profile. In accordance with one embodiment, at block 221, generating the spreading profile includes determining a baseline demand value for the individual target retail items in the set of target retail items based on the historical demand data. A baseline demand value for a target retail item may be determined simply by reading the baseline demand value from the historical demand data, in accordance with one embodiment. In accordance with another embodiment, a baseline demand value is calculated by the demand statistics logic 125 operating on the historical demand data.

Generating the spreading profile also includes, at block 222, generating a scaling factor for the individual target retail items in the set of target retail items by calculating a function of elasticity for the individual target retail items in the set of target retail items. Generating the spreading profile further includes, at block 223, multiplying the baseline demand values for the individual target retail items in the set of target retail items by the corresponding scaling factors for the target retail items, forming a plurality of multiplicative values. Generating the spreading profile also includes, at block 224, summing the plurality of multiplicative values to form a summed value and, at block 225, dividing each multiplicative value of the plurality of multiplicative values by the summed value to form the spreading profile.

Referring again to FIG. 2, at block 230, a first cross-promotion value is generated for at least one target retail item in the set of target retail items based on, at least in part, the spreading profile and the crossover amount. A cross-promotion value represents a predicted future change in a demand for a target retail item due to the planned promotion of the driver retail item. In accordance with one embodiment, the first cross-promotion value is generated by the demand prediction logic 140 of the cross-promotion forecasting tool 110 by distributing the crossover amount across the set of target retail items according to the spreading profile. Generation of the first cross-promotion value is discussed below herein with respect to the example of FIG. 6 and FIG. 7.

At block 240, a baseline demand value is determined for at least the same target retail item in the set of target retail items for which the first cross-promotion value is generated based on, at least in part, the historical demand data. A baseline demand value may represent average target retail item sales across the plurality of past retail periods. A baseline demand value may be determined simply by reading the baseline demand value from the historical demand data, in accordance with one embodiment. In accordance with another embodiment, a baseline demand value is calculated by the demand statistics logic 125 operating on the historical demand data.

At block 250, a second cross-promotion value is generated for at least the same target retail item in the set of target retail items for which the first cross-promotion value is generated based on, at least in part, the historical demand data and the baseline demand value for the target retail item. The second cross-promotion value represents a maximum change in a demand of a target retail item with respect to a baseline demand due to past promotion of the driver retail item. In accordance with one embodiment, the second cross-promotion value is generated by the demand statistics logic 125 of the cross-promotion forecasting tool 110. Generation of the second cross-promotion value is discussed below herein with respect to the example of FIG. 6 and FIG. 7.

At block 260, a minimum of the first cross-promotion value and the second cross-promotion value is selected as a final cross-promotion value for the corresponding target retail item in the set of target retail items. That is, the cross-promotion value that is smaller, between the first and second cross-promotion values, is selected as the final cross-promotion value. In this manner, the demand created by the cross-promotion effects takes into account historical values, such that the effects are not overestimated. Determining final cross-promotion values for the other target retail items in the set of target retail items may also be accomplished in accordance with the method 200.

The final cross-promotion value represents a final predicted future change in demand for a target retail item. An output data structure associated with, for example, the cross-promotion forecasting tool may be populated with the final cross-promotion values. In accordance with one embodiment, selection of a final cross-promotion value is accomplished by the demand prediction logic 125 of the cross-promotion forecasting tool 110. Selection of a final cross-promotion value is discussed below herein with respect to the example of FIG. 6 and FIG. 7.

In this manner, changes in demand for target retail items due to the promotion of a driver retail item may be predicted. The predicted changes in demand may be used to more accurately determine a promotion strategy (e.g., which retail item to promote and at what price) and more accurately determine quantities of the retail items to order.

FIG. 6 illustrates a first portion of one example embodiment of tables of data generated by the cross-promotion forecasting tool 110 of FIG. 1 by executing the method 200 of FIGS. 2-5. FIG. 7 illustrates a second portion of the example embodiment of FIG. 6 showing tables of data. Together, FIG. 6 and FIG. 7 provide an example of generating cross-promotion values for sets of target retail items that represent predicted future changes in demand for the target retail items due to promotion of driver retail items. The tables of FIG. 6 and FIG. 7 may be considered to represent data structures, for example, populated with various types of data as described below herein.

Referring to FIG. 6, table 610 shows product pairs of retail items. One driver retail item B is associated with three target retail items A, C, and D. That is, the demand for target retail items A, C, and D have been determined to be affected by the promotion of driver retail item B. Similarly, one driver retail item E is associated with two target retail items F and G such that the demand for target retail items F and G have been determined to be affected by the promotion of driver retail item E.

Therefore, table 610 shows two sets of target retail items. The first set of target retail items includes target retail items A, C, and D. The driver retail item for the first set of target retail items is driver retail item B. The second set of target retail items includes target retail items F and G. The driver retail item for the second set of target retail items is driver retail item E.

In FIG. 6, an elasticity value is given for each target retail item. For example, the elasticity value for target retail item A is −0.32. A negative elasticity value indicates that promotion of the driver retail item B has a cannibalization effect on the target retail item A. That is, the promotion of the driver retail item B will result in a decrease in the demand for the target retail item A. Similarly, the elasticity values for target retail items C and D are negative, indicating the cannibalization effect.

The elasticity value for target retail item F is 0.21. A positive elasticity value indicates that promotion of the driver retail item E has a halo effect on the target retail item F. That is, the promotion of the driver retail item E will result in an increase in the demand for the target retail item F. Similarly, the elasticity value for target retail item G is positive, indicating the halo effect. In accordance with one embodiment, the cross-promotion forecasting tool 110 reads the elasticity values from a data structure that is accessed via the graphical user interface provided by the visual user interface logic 120. The elasticity values may be electronically stored, for example, in the database device 160.

In accordance with one embodiment, the elasticity values, γᵢⱼ may be generated using a stepwise regression technique based on the following formula:

$$log ( \frac{{S}_{its}}{{\overline{S}}_{its}} ) = + {β}_{i 1} {PROMO}_{self , its} + {β}_{i 2} log ( {PRICE}_{self , its} ) + {\sum }_{j ∈ Λ , j \neq i} {γ}_{ij} log ( {LIFT}_{else , jts} )$$

$$Λ \text{:} The set of products which may have cross effects to product i$$

$${S}_{its} \text{:} Sales of product i at store s for period t$$

$${\overline{S}}_{its} \text{:} Baseline sales of product i at store s for period t$$

$${PROMO}_{self , its} \text{:} Promotion indicator of product i at store s for period t$$

$${PRICE}_{self , its} \text{:} \begin{matrix}Normalized price applied at \\ product i at store s for period t\end{matrix}$$

$${LIFT}_{else , jts} \text{:} Promotional lift for product j at store s for period t . \\ {γ}_{ij} \text{:} Promotion cross effect elasticity for product j to product i$$

Table 620 of FIG. 6 shows the baseline demand values for driver retail items B and E. Again, a baseline demand value for a driver retail item may represent average driver retail item sales across a plurality of past retail periods. In accordance with one embodiment, baseline demand values are part of the historical demand data and the cross-promotion forecasting tool 110 reads the baseline demand values from a data structure. The data structure may be accessed via the graphical user interface provided by the visual user interface logic 120, in one embodiment. In accordance with another embodiment, the baseline demand values are calculated by the demand statistic logic 125 of the cross-promotion forecasting tool 110 operating on the historical demand data. Baseline demand may be estimated in accordance with a fairly complex formula, in accordance with certain embodiments.

Table 620 also shows cross change ratios (CCR) for driver retail items B and E. In accordance with one embodiment, the cross change ratios are calculated by the crossover logic 135 of the cross-promotion forecasting tool 110 operating on the historical demand data. Again, a cross change ratio represents a fraction of the expected future change in demand for a driver retail item that accounts for the total expected future change in demand for a set of target retail items. For example, if the expected future change in demand for a driver retail item is an increase in 100 units due to promotion of the driver retail item, and the cross change ratio is 0.25 (or 25%), then the set of target retail items affected by promotion by the driver retail item will be affected by 25 total units.

The cross change ratio may also be described as the ratio of the sum of the change in sales units (the absolute value of actual sales minus the baseline demand) of the target retail items caused by the cross promotion effect versus the change in sales of the driver retail item due to promotion of the driver retail item. In accordance with one embodiment, the cross change ratio, CCR(j), may be calculated by the following formula:

$$CCR ( j ) = \frac{1}{P} ( \frac{{\sum }_{i ∈ Δ} \vert S\_chg ( it ) \vert}{S\_lift ( jt )} )$$

P is the total number of periods when the driver retail item j was promoted in the sales history. S_chg(it) is the change in sales units of the target retail item i at period t caused by the promotion of the driver retail item j. S_lift(jt) is the self change in sales units of the driver retail item j at period t when the driver retail item j is on promotion. Δ is the set of target retail items upon which the driver retail item j has cross effects.

Table 630 shows the spreading profile for the set of target retail items (A, C, D, F, G). Again, the spreading profile is used to determine how the crossover value will be distributed across or allocated to the target retail items in the set of target retail items. In accordance with one embodiment, the spreading profile is generated by the spreading profile logic 130 operating on the historical demand data and the elasticity values.

In accordance with one embodiment, the spreading profile, sp(i,j), may be calculated in accordance with the following formula:

$$sp ( i , j ) = ( \frac{{\vert 1 - {e}^{{γ}_{ij}} \vert}^{*} b ( i )}{{\sum }_{k ∈ Λ} {\vert 1 - {e}^{{γ}_{kj}} \vert}^{*} b ( k )} )$$

Λ is the set of target retail items upon which the driver retail item j has cross effects. b(i) are the average baseline sales of target retail item i along the sales history. γᵢⱼ is the cross effect elasticity (elasticity value) from driver retail item j to target retail item i.

The absolute value of (1−e^{γ}^{ᵢⱼ}), or of (1−e^{γ}^{ₖⱼ}), is a scaling factor. The absolute value is used because the resultant value would be negative for halo effects, and it is desired, in one embodiment, that the scaling factor be positive. Notice in table 630 that the values of the spreading profile for target retail items A, C, and D, which are associated with the driver retail item B, sum to a value of 1.0. Similarly, the values of the spreading profile for target retail items F and G, which are associated with the driver retail item E, sum to a value of 1.0.

Referring to FIG. 7, table 710 shows a maximum sales change ratio (MCR) for each target retail item in the set of target retail items. The MCR is the ratio of the maximum change in sales units (demand) for a target retail item, due to the cross promotion effect from a driver retail item, against the baseline demand for the target retail item. For example, the MCR for target retail item A is 0.10 (or 10%) indicating that, according to the historical demand data, the demand for target retail item A never changed by more than 10% when driver retail item B was promoted.

In accordance with one embodiment, the MCR may be generated by the demand statistics logic 125 of the cross-promotion forecasting tool 110 as part of generating a second cross-promotion value for each target retail item of a set of target retail items. The second cross-promotion value represents a maximum change in demand of a target retail item with respect to a baseline demand due to past promotion of a driver retail item.

For example, the second cross-promotion value for a target retail item i may be calculated in accordance with the following formula:

second cross-promotion value(i)=b(i)*MCR(i),

as shown in table 730, where b(i) is the baseline demand value and MCR(i) is the maximum sales change ratio for the target retail item i.

Table 720 shows a promotional lift expected to be experienced by each of the driver retail items B and E due to promotion of the driver retail items B and E. For example, if the baseline demand for driver retail item B is 24 units as shown in table 620, then the demand for driver retail item B will increase by 19.2 units (see table 730) when on promotion due to the promotional lift of 80%. Similarly, if the baseline demand for driver retail item E is 30 units as shown in table 620, then the demand for driver retail item E will increase by 15 units (see table 730) when on promotion due to the promotional lift of 50%.

The increase in units is the global lift value for the driver retail items. In accordance with one embodiment, the global lift value and the cross change ratio for a driver retail item are multiplied together to form the crossover amount. In accordance with one embodiment, the crossover amount is generated by the crossover logic 135 of the cross-promotion forecasting tool 110.

Table 730 shows the cross-promotion values (first, second, and final), in retail item units, for each target retail item in the set of target retail items. Again, a cross-promotion value (CPV) represents a predicted future change in demand for a target retail item due to the planned promotion of a driver retail item. As seen in table 730, the final cross-promotion value for a target retail item i, when a driver retail item j is promoted, is the minimum of the first and second cross promotion values for each target retail item as given by the following formula:

cross_unit(i,j)=min(sp(i,j)*S_lift(j)*ccr(j),b(i)*mcr(i))

As seen from the above formula, the first cross-promotion value for a target retail item may be calculated by multiplying the corresponding spreading profile element, sp(i,j), by the global lift value, S_lift(j), and the cross change ratio, ccr(j). The spreading profile element sp(i,j) drives the distribution of a portion of the crossover amount to target retail item i. Similarly, from the above formula, the second-cross promotion value for a target retail item may be calculated by multiplying the corresponding baseline demand value, b(i), by the corresponding maximum sales change ratio, mcr(i).

The final cross promotion value for target retail item A is about one unit, the final cross promotion value for target retail item C is about two units, and the final cross promotion value for target retail item D is about a half a unit. Therefore, for example, when driver retail item B is promoted in the future, the demand for target retail item C is expected to decrease by about two units due to the cannibalization effect. Similarly, target retail items A and D are expected to be cannibalized by about one unit and about half a unit, respectively.

The final cross promotion value for target retail item F is about three units, and the final cross promotion value for target retail item G is about two units. Therefore, for example, when driver retail item E is promoted in the future, the demand for target retail item F is expected to increase by about three units due to the halo effect. Similarly, the demand for target retail item G is expected to increase by about two units.

In this manner, cross-promotion effects (halo, cannibalization) may be predicted, taking into account the history of the retail items. The predicted cross-promotional information may be used to adjust order quantities for the retail items and predict future inventory levels of the retail items. In accordance with one embodiment, an order quantity for a retail item may be transformed based on a final cross-promotion value.

For example, a replenishment system can use this information to adjust order quantities and reduce inventory cost. For example, in accordance with one embodiment and based on the example above, an order quantity for target retail item F may be reduced by three units to account for the expected decrease in sales due to the cannibalization. A reduction in inventory cost of as little as 1% can amount to millions of dollars in savings per year for some retailers. In this manner, a retailer can more accurately forecast and manage demand for merchandise by mitigating the cross-promotion effects that can be caused by promotion of driver retail items.

Systems, methods, and other embodiments that are associated with a computer application configured to execute on a computing device, for providing forecasting and management of cross-promoted retail items, have been described. In one embodiment, historical demand data and elasticity values associated with retail items sold at a retail location are read from a data structure. The historical demand data represents past sales of the retail items across a plurality of past retail periods, and the elasticity values represent how sensitive demand for the retail items are to a change in demand of a promoted retail item. Cross-promotion values for affected retail items are generated, based at least in part on the historical demand data and the elasticity values, representing a predicted future change in demand for the affected retail items due to the planned promotion of another retail item.

Computing Device Embodiment

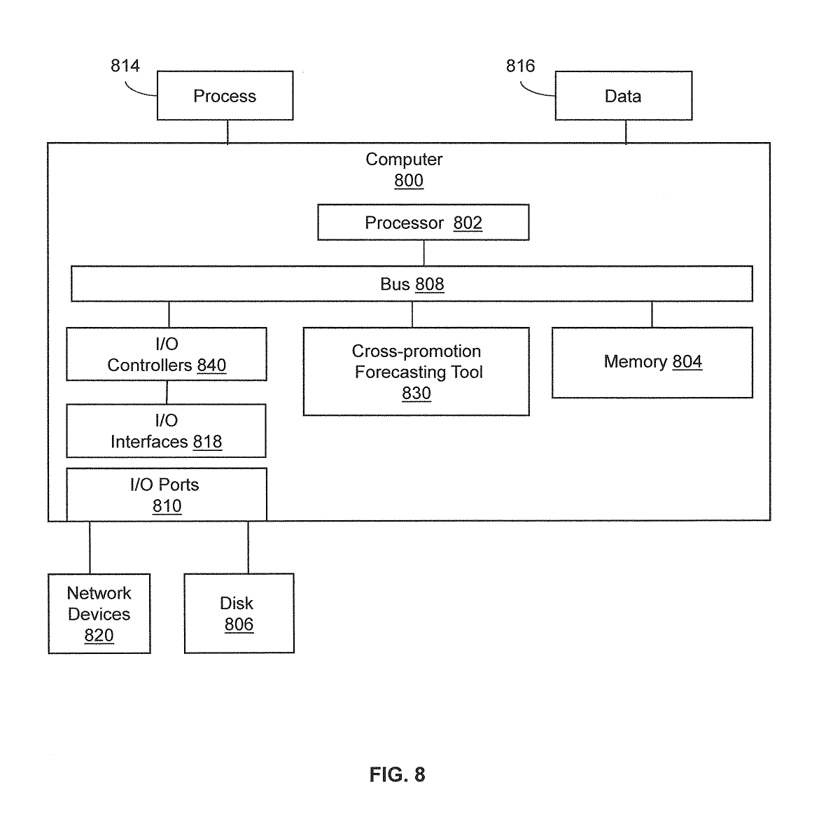

FIG. 8 illustrates an example computing device that is configured and/or programmed with one or more of the example systems and methods described herein, and/or equivalents. FIG. 8 illustrates one example embodiment of a computing device upon which an embodiment of a cross-promotion forecasting (CPF) tool may be implemented. The example computing device may be a computer 800 that includes a processor 802, a memory 804, and input/output ports 810 operably connected by a bus 808.

In one example, the computer 800 may include CPF tool 830 (corresponding to CPF tool 110 from FIG. 1) configured with a programmed algorithm as disclosed herein to determine cross-promotion values representing predicted future changes in demand for target retail items due to the planned promotion of a driver retail item. The cross-promotion values may be displayed as values on a computing display device. In different examples, the tool 830 may be implemented in hardware, a non-transitory computer-readable medium with stored instructions, firmware, and/or combinations thereof. While the tool 830 is illustrated as a hardware component attached to the bus 808, it is to be appreciated that in other embodiments, the tool 830 could be implemented in the processor 802, stored in memory 804, or stored in disk 806.

In one embodiment, tool 830 or the computer 800 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the forecasting and managing of promoted and cross-promoted merchandise for a retailer. The means may also be implemented as stored computer executable instructions that are presented to computer 800 as data 816 that are temporarily stored in memory 804 and then executed by processor 802.

Tool 830 may also provide means (e.g., hardware, non-transitory computer-readable medium that stores executable instructions, firmware) for facilitating the predicting of cross-promotion effects between retail items.

Generally describing an example configuration of the computer 800, the processor 802 may be a variety of various processors including dual microprocessor and other multi-processor architectures. A memory 804 may include volatile memory and/or non-volatile memory. Non-volatile memory may include, for example, ROM, PROM, and so on. Volatile memory may include, for example, RAM, SRAM, DRAM, and so on.

A storage disk 806 may be operably connected to the computer 800 via, for example, an input/output interface (e.g., card, device) 818 and an input/output port 810. The disk 806 may be, for example, a magnetic disk drive, a solid state disk drive, a floppy disk drive, a tape drive, a Zip drive, a flash memory card, a memory stick, and so on. Furthermore, the disk 806 may be a CD-ROM drive, a CD-R drive, a CD-RW drive, a DVD ROM, and so on. The memory 804 can store a process 814 and/or a data 816, for example. The disk 806 and/or the memory 804 can store an operating system that controls and allocates resources of the computer 800.

The computer 800 may interact with input/output devices via the i/o interfaces 818 and the input/output ports 810. Input/output devices may be, for example, a keyboard, a microphone, a pointing and selection device, cameras, video cards, displays, the disk 806, the network devices 820, and so on. The input/output ports 810 may include, for example, serial ports, parallel ports, and USB ports.

The computer 800 can operate in a network environment and thus may be connected to the network devices 820 via the i/o interfaces 818, and/or the i/o ports 810. Through the network devices 820, the computer 800 may interact with a network. Through the network, the computer 800 may be logically connected to remote computers. Networks with which the computer 800 may interact include, but are not limited to, a LAN, a WAN, and other networks.

### DEFINITIONS AND OTHER EMBODIMENTS

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. §101.

“User”, as used herein, includes but is not limited to one or more persons, computers or other devices, or combinations of these.

“Operable interaction”, as used herein, refers to the logical or communicative cooperation between two or more logics via an operable connection to accomplish a function.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A method implemented by a computing device configured to execute a computer application, wherein the computer application is configured to process data in electronic form, the method comprising:
generating a crossover amount based at least in part on historical demand data, wherein the crossover amount represents an expected future change in a demand of target retail items caused by a change in a demand of a driver retail item due to a planned promotion of the driver retail item; and
distributing the crossover amount across the target retail items stored as values in a data structure, based at least in part on the historical demand data and elasticity values, to form a first cross-promotion value for at least one target retail item of the target retail items representing a predicted future change in a demand for the at least one target retail item, wherein the elasticity values represent how a change in the demand of the driver retail item affects changes in the demand of the target retail items.

2. The method of claim 1, wherein the distributing the crossover amount comprises generating a spreading profile by:
determining baseline demand values for the target retail items;
generating scaling factors for the target retail items by calculating a function of elasticity for the target retail items;
multiplying the baseline demand values for the target retail items by the scaling factors that individually correspond to the target retail items to form a plurality of multiplicative values;
summing the plurality of multiplicative values to form a summed value; and
dividing each multiplicative value of the plurality of multiplicative values by the summed value to form the spreading profile.

3. The method of claim 1, wherein the target retail items and the driver retail item are for sale at a retail location that includes one of a physical store or an on-line store.

4. The method of claim 1, further comprising:
determining a baseline demand value for the at least one target retail item based at least in part on the historical demand data, where the baseline demand value represents average sales of the at least one target retail item; and
generating a second cross-promotion value for the at least one target retail item based at least in part on the historical demand data and the baseline demand value, wherein the second cross-promotion value represents a maximum change in the demand of the at least one target retail item due to at least one past promotion of the driver retail item.

5. The method of claim 4, further comprising selecting a minimum of the first cross-promotion value and the second cross-promotion value as a final cross-promotion value representing a final predicted future change in the demand for the at least one target retail item.

6. The method of claim 5, further comprising populating an output data structure with the final cross-promotion value for the at least one target retail item.

7. The method of claim 1, wherein the generating the crossover amount comprises:
generating a cross change ratio for the driver retail item based at least in part on the historical demand data, wherein the cross change ratio represents a fraction of an expected future change in the demand of the driver retail item that accounts for the expected future change in the demand of the target retail items;
generating a global lift value for the driver retail item based at least in part on the historical demand data, where the global lift value represents an expected future increase in the demand of the driver retail item due to the planned promotion of the driver retail item; and
multiplying the global lift value by the cross change ratio to form the crossover amount.

8. The method of claim 7, wherein the generating the cross change ratio comprises:
determining a total number of past time periods over which the driver retail item was promoted;
generating a target change value representing a change in the demand of the target retail items for at least one time period of the total number of past time periods;
generating a driver lift value representing an increase in the demand for the driver retail item for the at least one time period; and
dividing the target change value by the total number of past time periods and the driver lift value to form the cross change ratio.

9. The method of claim 8, wherein the at least one time period represents one of a day, a week, a month, or a year.

10. A computing system, comprising:
crossover logic configured to generate a crossover amount based at least in part on historical demand data, wherein the crossover amount represents an expected future change in a demand of target retail items caused by a change in a demand of a driver retail item due to a planned promotion of the driver retail item; and
demand prediction logic operably connected to the crossover logic and configured to generate a first cross-promotion value for individual retail items of the target retail items based at least in part on the historical demand data, elasticity values, and the crossover amount, wherein the elasticity values represent how a change in the demand of the driver retail item affects changes in the demand of the target retail items, and wherein the first cross-promotion value represents a predicted future change in a demand for an associated retail item of the target retail items due to the planned promotion of the driver retail item.

11. The computing system of claim 10, further comprising visual user interface logic operably connected to at least the demand prediction logic and configured to facilitate inputting of the historical demand data and the elasticity values into one or more data structures.

12. The computing system of claim 10, further comprising a display screen configured to display and facilitate user interaction with at least a graphical user interface.

13. The computing system of claim 10, wherein the demand prediction logic is configured to facilitate displaying the first cross-promotion value.

14. The computing system of claim 10, further comprising spreading profile logic operably connected to at least the demand prediction logic and configured to generate a spreading profile based at least in part on the historical demand data and the elasticity values, wherein the spreading profile represents how to distribute the crossover amount across the target retail items.

15. The computing system of claim 10, further comprising demand statistics logic operably connected to the crossover logic and the demand prediction logic and configured to:
generate a baseline demand value for the individual retail items of the target retail items based at least in part on the historical demand data, wherein the baseline demand value represents an average historical demand of the associated retail item; and
generate a second cross-promotion value for the individual retail items of the target retail items based at least in part on the historical demand data and the baseline demand value for the associated retail item, wherein the second cross-promotion value represents a maximum change in the demand of the associated retail item due to past promotion of the driver retail item.

16. The computing system of claim 15, wherein the demand prediction logic is configured to select a minimum of the first cross-promotion value and the second cross-promotion value as a final cross-promotion value for the individual retail items of the target retail items, wherein the final cross-promotion value represents a final predicted future change in the demand of the associated retail item.

17. A non-transitory computer-readable medium storing computer-executable instructions that are part of an algorithm that, when executed by a computer, cause the computer to perform a method, wherein the instructions comprise instructions configured for:
generating a crossover amount based at least in part on historical demand data for a driver retail item and target retail items, wherein the crossover amount represents an expected future change in a demand of the target retail items caused by a change in a demand of the driver retail item due to a planned promotion of the driver retail item;
generating a spreading profile based at least in part on the historical demand data and elasticity values, wherein the elasticity values represent how a change in the demand of the driver retail item affects changes in the demand of the target retail items, and wherein the spreading profile represents how to distribute the crossover amount across the target retail items; and
generating a first cross-promotion value for at least one target retail item of the target retail items based at least in part on the spreading profile and the crossover amount, wherein the first cross-promotion value represents a predicted future change in a demand for the at least one target retail item due to the planned promotion of the driver retail item.

18. The non-transitory computer-readable medium of claim 17, wherein the instructions further include instructions configured for generating a second cross-promotion value for the at least one target retail item based at least in part on the historical demand data, wherein the second cross-promotion value represents a maximum change in the demand of the at least one target retail item due to at least one past promotion of the driver retail item.

19. The non-transitory computer-readable medium of claim 18, wherein the instructions further include instructions configured for selecting a minimum of the first cross-promotion value and the second cross-promotion value as a final cross-promotion value for the at least one target retail item, wherein the final cross-promotion value represents a final predicted future change in the demand for the at least one target retail item.

20. The non-transitory computer-readable medium of claim 19, wherein the instructions further include instructions configured for populating an output data structure with the final cross-promotion value for the at least one target retail item.
